(19) United States
(12) Patent Application Publication
(10) Pub. No.: US 2010/0322135 A1
(43) Pub. Date: Dec. 23, 2010

(54) APPARATUS AND METHOD FOR SIGNALLING SUB-FRAME ALLOCATION PATTERN

(75) Inventors: Gert-Jan Van Lieshout, Staines Middlesex (GB); Himke Van Der Velde, Staines Middlesex (GB); Soeng-Hun Kim, Gyeonggi-do (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/820,832

(22) Filed: Jun. 22, 2010

(30) Foreign Application Priority Data
Jun. 22, 2009 (GB) 0910799.6

(51) Int. Cl. H04W 72/04; H04H 20/71

(52) U.S. Cl. 370/312; 370/329

(57) ABSTRACT

An apparatus and method for signalling sub-frame allocation pattern. The present invention is provided a method of signalling a sub-frame allocation pattern to apparatus (e.g. UE) adapted to receive wirelessly and extract data from a radio signal (e.g. a signal carrying MBMS channels) comprising a series of radio frames, each radio frame comprising a plurality of sub-frames for carrying data, the sub-frame allocation pattern indicating the position of at least each sub-frame, in the series of radio frames, allocated to carry data of one respective data channel (e.g. one MCH) of a plurality of data channels. The method comprises providing the apparatus with an indication of a set of sub-frames (e.g. a common sub-frame pool), in the series of radio frames, reserved for carrying data of said plurality of data channels (e.g. the MCHs), and providing the apparatus with an indication of a at least one sub-set (e.g. a sub-set of the common pool allocated to a particular MCH) of the set of sub-frames allocated to carry data of a respective one of said data channels.

### PRIORITY

This patent application claims priority under 35 U.S.C. §119(e) to a patent application filed in the United Kingdom Intellectual Property Office on Jun. 22, 2009 and assigned Serial No. GB0910799.6, the content of which is incorporated herein by reference.

### BACKGROUND OF THE INVENTION

1. Field of the Invention

The present invention relates generally to radio signals including radio frames, and more particularly to an apparatus and method of signalling a sub-frame allocation pattern.

2. Description of the Related Art

A variety of radio signals comprising a series of radio frames divided into sub-frames for carrying data are known. For example, the current status with respect to the introduction of MBMS (Multimedia Broadcast Multicast Service) in REL-9 of the Evolved Universal Terrestrial Radio Access (E-UTRA) can be summarised as follows.

REL-8: SIB2 SAPs (System Information Block—Subframe Allocation Patterns)

REL-8 already includes some provisions for introducing MBMS in a later release. In particular, EUTRAN can broadcast information regarding sub-frames for which a REL-8 UE may assume that no DL (DownLink) data will be transferred. More specifically, EUTRAN provides the information about sub-frames that are reserved for future (e.g. for MBMS) by means of the field mbsfn-SubframeConfigList that is contained in the SystemInformationBlockType2. Although the name of the field is mbms-specific, the corresponding sub-frames may be reserved for other purposes also. One other use case that has been discussed is the use for relaying (the introduction of relays is assumed to be part of REL-10 of EUTRA).

The UE behaviour associated with this field is specified in TS 36.331, sub-clause 5.2.2.9 (see extract below):

1> if the mbsfn-SubframeConfigList is included:

2> consider that no other DL assignments occur in a MBMS over a Single Frequency Network (MBSFN) subframes indicated in the IE mbsfn-SubframeConfigList:

The contents of the mbsfn-SubframeConfigList field is illustrated by means of the following ASN.1, again extracted from TS 36.331:

```
-  Extract from 6.3.1: System information blocks
MBSFN-SubframeConfigList ::= SEQUENCE (SIZE
(1..maxMBSFN-Allocations) OF MBSFN-SubframeConfig
  MBSFN-SubframeConfig ::=  SEQUENCE {
  radioframeAllocationPeriod  ENUMERATED {n1, n2, n4, n8,
  n16, n32},
  radioframeAllocationOffset  INTEGER (0..7),
```

| | |
|---|---|
| subframeAllocation | CHOICE { |
| oneFrame | BIT STRING <SIZE(6)), |
| fourFrames | BIT STRING <SIZE(24)) |
| } | |
| } | |

- Extract from 6.4: Multiplicity and type constraint definition
maxMBSFN-Allocations INTEGER ::= 8 -- Maximum number
of MBSFN frame allocations with different offset

The above extract shows that SIB2 can include up to 8 sub-frame allocation patterns (SAPs), which from now on are referred to as SIB2 SAPs. A pattern can either comprise of one or four radio frames, occurring in a cycle defined by the AllocationPeriod and starting from the AllocationOffset. It should be noted that only sub-frames 1-3 and 6-8 can be reserved for future MBMS usage. A bit string is used to indicate which of these possible sub-frames are actually allocated for a given SIB2 SAP.

The following example illustrates the use of the SIB2 SAPs:

The field mbsfn-SubframeConfigList is set, as illustrated by the following ASN.1 extract, to include:

a) one SAP in which sub-frame 6 is allocated in every radio frame and

b) one SAP in which sub-frame 1 is allocated in every uneven radio frame:

```
-  mbsfn-SubframeConfigList example setting
mbsfn-SubframeConfigList ::=  {{
  radioframeAllocationPeriod  n1,
  radioframeAllocationOffset  0,
  subframeAllocation: oneFrame  ‘000100’
  }
  radioframeAllocationPeriod  n2,
  radiofrmaeAllocationOffset  1,
  subframeAllocation: oneFrame  ‘100000’
}
```

FIG. 1 illustrates the two SIB2 SAPs in a graphical manner. The figure shows two radio frames with the subframes marked light grey are the one that can be allocated to mbsfn, while the ones marked dark grey are actually allocated for the concerned SAP.

The example illustrates one possible way to reserve on average 1.5 subframes in each radio frame.

It should be noted that:
the above SIB2 SAP configuration can equally well be provided by means of a fourFrame allocation pattern (although that would require a few mo re bits)
especially for larger allocations, the granularity is somewhat limited

Further information on the general background and status of MBMS is as follows.

Although a lot of aspects regarding the introduction of MBMS in REL-9 of EUTRA are still undecided, a number of agreements have been reached. The background information as well as agreements that are relevant for understanding the present invention are as follows:
MBMS is supported only on carriers that are also used to transfer unicast data
MBMS is provided by means of multi-cell transmission, which is used both for control and user data. This mode of operation, which involves synchronised transmission from all participating cells, is referred to as MBSFN
The area covered by the participating cells of such a synchronised transmission is referred to as the MSFSN area. A cell could take part in MBMS transmissions corresponding to different MBSFN areas in which case MBSFN areas overlap. Support of overlapping MBSFN areas is regarded as not essential i.e. it is supported only if the associated impacts are small
Some background regarding the MBMS specific radio protocol architecture is:
Most of the MBMS control information is provided on a MBMS point-to-multipoint Control Channel (MCCH), which is the logical channel specific to MBMS. A small part of the MBMS control information is however provided on a Broadcast Control Channel (BCCH), which is the general broadcast logical channel. The MBMS information on BCCH is kept to a minimum i.e. it mainly concerns information required to ‘find’ the MCCH
MBMS user data is provided on a MBMS point-to-multipoint Traffic Channel (MTCH) logical channel. There is an MTCH logical channel for each service for which transmission is ongoing
The information corresponding with the MCCH and MTCH logical channels is transferred via the MCH transport channel, which is again transmitted on the PMCH physical channel.

The allocation of radio resources to an (P)MCH is specified by means of an MCH Subframe Allocation Pattern i.e. the MSAP defines which subframes within a given periodic cycle are allocated to a specific (P)MCH

EUTRAN provides information regarding the scheduling of services. This information, which is provided per (P)MCH, is signalled to the UE at the start of each scheduling period. The scheduling period is referred to as an MSAP occasion. It should be noted that, within an MSAP occasion, all user data corresponding to an MCH is scheduled in subsequent subframes that are allocated to the concerned (P)MCH. Hence, for each service that is scheduled, EUTRAN just needs to provide an indication of the start and the duration
If multiple MBSFN areas are supported, there is one MCCH per MBSFN area. Although it is still undecided if the protocol should support multiple MCH within an MB SFN area, at least certain embodiments of the present invention assume such support is provided

Further background, information on agreements, and information on assumptions regarding the MBMS protocol architecture/ design is as follows:
It has been agreed that the MBMS control information provided on MCCH is carried by a single message. The name of this message has not been agreed yet, but in this specification it is referred to as the MBSFNAreaConfiguration message (since MCCH, and hence this message, concerns one MBSFN area)

With regard to the issue of any proposed MBSFN subframe allocation scheme, so far there is no agreement on how to signal the MSAP i.e. the subframes allocated to a specific MCH. Only one concrete proposal has been provided in 3GPP RAN2 so far, with characteristics as follows:
The MSAP is an index, pointing to one of the subframe allocation patterns (SAP) included in SIB2

This scheme is illustrated by the following ASN.1 extract.

```
-  Extract from 6.3.7: MBMS information elements (alternative)
PMCH-Config ::=  SEQUENCE {
  msap-Config  INTEGER (1.. maxMBSFN-Allocation),
  modulationAndCodingSheme  INTEGER (0.. 63),
  msap-OccasionPeriodicity  ENUMERATED {
                    ms160, ms320, ms480, ms640, ms800, ms960,
                    ms1280, ms1600}
}
```

Accordingly, the present invention provide a method of allocating MBSFN subframe and/or a methods of signalling MBSFN SAPs. The present invention is not limited to MBSFN (Multi-media Broadcast over a Single Frequency Network) applications, however, and alternative embodiments are concerned with SAPs for other radio signals.

### SUMMARY OF THE INVENTION

According to a first aspect of the present invention there is provided a method of signalling a sub-frame allocation pattern to apparatus (e.g. UE) adapted to receive wirelessly and extract data from a radio signal (e.g. a signal carrying MBMS channels) comprising a series of radio frames, each radio frame comprising a plurality of sub-frames for carrying data, the sub-frame allocation pattern indicating the position of at least each sub-frame, in the series of radio frames, allocated to carry data of one respective data channel (e.g. one MCH) of a plurality of data channels, the method comprising:

providing the apparatus with an indication of a set of sub-frames (e.g. a common sub-frame pool), in the series of radio frames, reserved for carrying data of said plurality of data channels (e.g. the MCHs); and

providing the apparatus with an indication of a at least one sub-set (e.g. a sub-set of the common pool allocated to a particular MCH) of the set of sub-frames allocated to carry data of a respective one of said data channels.

In certain embodiments, each sub-set comprises a respective single sub-frame or a respective plurality of consecutive sub-frames from said set.

In certain embodiments, providing the apparatus with said indication of at least one sub-set comprises providing the apparatus with an indication of the respective number of sub-frames in each sub-set and the respective position of the first sub-frame of each sub-set in the series of radio frames.

In certain embodiments, providing the apparatus with an indication of the respective number of sub-frames in each sub-set and the respective position of the first sub-frame of each sub-set in the series of radio frames comprises:

providing the apparatus with at least one of: a length of each sub-set; a position of the start of each sub-set; and a position of the end of each sub-set, in the set of sub-frames.

In certain embodiments, the method further comprises:

providing the apparatus with an indication of a super-set of sub-frames (e.g. a general pool of sub-frames reserved for future use—MBSFN or other purposes), in the series of radio frames, reserved for at least one use, wherein said set of sub-frames (e.g. a specific pool of subframes reserved for one purpose, such as for one MBSFN area) is a sub-set of the super-set.

In certain embodiments, said at least one use includes MBSFN use and at least one different use.

In certain embodiments, providing the apparatus with an indication of the super-set of sub-frames comprises:

providing information identifying the sub-frames of the super-set in a System Information Block (SIB).

In certain embodiments the set of sub-frames is a set reserved for an MBSFN area.

In certain embodiments, providing the apparatus with an indication of the set of sub-frames comprises:

providing information identifying the set of sub-frames within an MBMS control information message on MCCH.

In certain embodiments the apparatus is user equipment (UE).

In certain embodiments the plurality of data channels are multicast channels.

In certain embodiments the plurality of data channels are transmitted via a single frequency network.

In certain embodiments the sub-frame allocation pattern is signalled within an MBMS control information message.

In certain embodiments the method is implemented in a mobile communication system, the mobile communication system comprising a plurality of access points for forming an MBMS single frequency network area, wherein the multicast channels are synchronized within the MBMS single frequency network area.

In certain embodiments the system information block is transmitted via a broadcast channel.

Another aspect of the invention provides a method of allocating data to a radio signal in a sub-frame allocation pattern, the radio signal comprising a series of radio frames, each radio frame comprising a plurality of sub-frames for carrying data, the sub-frame allocation pattern indicating the position of at least each sub-frame, in the series of radio frames, allocated to carry data of one respective data channel of a plurality of data channels, the method comprising:

reserving a set of sub-frames, in the series of radio frames, for carrying data of said plurality of data channels; and

allocating at least one sub-set of the set of sub-frames to carry data of a respective one of said data channels.

In certain embodiments, each sub-set comprises a respective single sub-frame or a respective plurality of consecutive sub-frames from said set.

Another aspect of the invention provides a method of generating a radio signal comprising a series of radio frames, each radio frame comprising a plurality of sub-frames for carrying data, the radio signal carrying data of at least one respective data channel of a plurality of data channels, the method comprising:

allocating data to the radio signal in a sub-frame allocation pattern using a method in accordance with another aspect of the invention; and

carrying data of at least one of said plurality of channels in the respective sub-set of sub-frames.

Another aspect of the invention provides a radio signal generated using a method in accordance with another aspect.

Another aspect of the invention provides apparatus adapted to implement a method in accordance with any other aspect.

Another aspect of the invention provides apparatus adapted to receive wirelessly and extract data from a radio signal comprising a series of radio frames, each radio frame comprising a plurality of sub-frames for carrying data of a plurality of data channels, and adapted to receive a sub-frame allocation pattern, for the radio signal, signalled using a method in accordance with any aspect of the invention, the apparatus being further adapted to extract data corresponding to at least one said data channel from an indicated respective sub-set of sub-frames.

Another aspect provides a communication method comprising:

generating a radio signal using a method in accordance with any aspect of the invention;

wirelessly transmitting the radio signal to apparatus;

signalling a sub-frame allocation pattern for the radio signal to the apparatus using a method in accordance with any aspect of the invention; and

using the signalled sub-frame allocation pattern to extract data for at least one of said data channels from a respective sub-set of sub-frames.

Another aspect provides a communication system adapted to implement a method in accordance with any aspect of the invention.

### BRIEF DESCRIPTION OF THE DRAWINGS

Embodiments of the invention will now be described with reference to the accompanying figures, of which:

FIG. 1 illustrates two different SIB2 subframe allocation patterns which may be used in embodiments of the invention which may be used in embodiments of the invention;

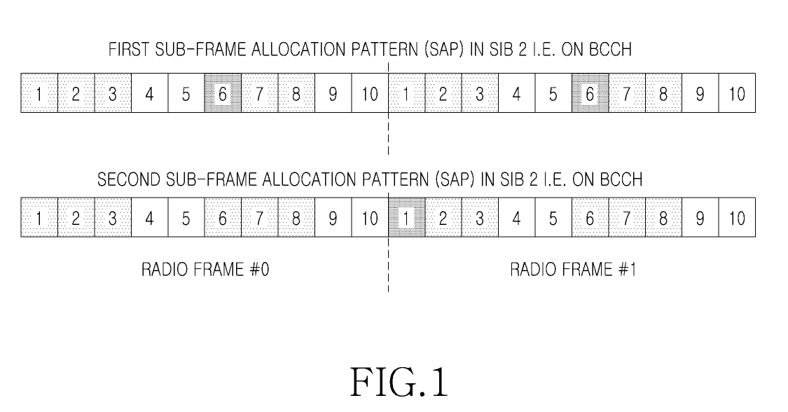

FIG. 2 illustrates three SIB2 subframe allocation patterns which may be used in embodiments of the invention;

FIG. 3 illustrates the allocation of common subframes to individual PMCHs in embodiments of the invention;

FIG. 4 illustrates a message sequence including steps in the UE operation in embodiments of the invention;

FIG. 5 illustrates an example of finer granularity by using multiple SAPs;

FIG. 6 illustrates an example of allocation of 1.5 subframes per radio frame to a given MBSFN area & 1 subframe per radio frame to relaying;

FIG. 7 illustrates an example of interleaving of MCH in case of MSAP duration of rf4 (4 radio frames) and MSAP occasion of rf64; and

FIG. 8 is illustrated an example without MCH interleaving of MCH.

### DETAILED DESCRIPTION OF EMBODIMENTS OF THE INVENTION

The present invention relates to radio signals comprising radio frames, which themselves comprise sub-frames, and in which data of at least one channel from a plurality of data channels is allocated to the sub-frames according to a sub-frame allocation pattern. Particular embodiments are concerned with the signalling of these sub-frame allocation patterns to recipient apparatus, such as user equipment (UE).

It will be appreciated from the above discussion, and from the following description, that particular embodiments of the invention are concerned with the optimised/improved signalling of MBSFN allocation patterns (MSAP)

Certain embodiments are concerned with 3GPP standards, and some relevant technical specifications (TS) related to Multimedia Broadcast Multicast Services (MBMS) are:
25.992: Requirements
23.246: Architecture and Functional Description
25.346: UMTS Stage 2 Description
43.246: GERAN Stage 2 Description
26.346: Protocols and Codecs
25.905: Study on MBMS Enhancements for Re1.7,

the contents of each of which are incorporated herein by reference

Certain embodiments apply to REL-9 of the Evolved Universal Terrestrial Radio Access (E-UTRA) in which support for MBMS is introduced. Certain embodiments provide a method for signalling the subframes that allocated to a specific MCH (Multicast Channel).

Certain embodiments utilise/comprise the following features:

Common subframe pool (CSP): the field commonSubframePool that is included in the MBSFNAreaConfiguration message indicates which of the subframes reserved for future use, as indicated by the mbsfn-SubframeConfigList field within the SysteminformationNockType2, together form a common pool of subframes that are shared by the (P)MCHs included in the MBSFNAreaConfiguration message. This common pool of subframes refer to the “set” of sub-frames.
This concerns all (P)MCH indicated by this MCCH i.e. all (P)MCH with the same MBSFN area as the MCCH on which the message is transferred
This may be realised by 1 bit for each of the SAPs included in the mbsfn-SubframeConfigList field i.e. a bit indicating if the concerned SAP is part of this CSP
This signalling option not only facilitates support of multiple MBSFN areas, but also facilitates use of these reserved subframes for purposes other than MBSFN e.g. relaying
   Subsequent subframes out of this common set of subframes are allocated to individual (P)MCH. The subframes allocated to an individual (P)MCH refer to a respective “sub-set” of the “set”. This allocation is controlled by two or three parameters: an allocation period, a size and possibly a start or offset
   Common allocation period: the commonAllocationPeriod that is included in the MBSFNAreaConfiguration message concerns a period of time over which the common subframes are allocated to individual (P)MCH. One reason for having this parameter is that the SIB2 SAPs may apply different allocation periods. This parameter may be set to the smallest common denominator of the allocation period used by the relevant SIB2 SAPs. However, larger values may be used in case additional granularity is desired.
   For each individual (P)MCH, the following parameters are provided:
Allocation size: the field allocationSize indicates the number of subsequent subframes out of the common subframe pool that, within each allocation period, is allocated to an individual (P)MCH.
Allocation start or offset: the field allocationStart indicates the first subframe out of the common subframe pool that, within each allocation period, is allocated to an individual (P)MCH. The start of offset may be absent since the start of a given (P)MCH can be derived by adding up the allocation sizes of the (P)MCH that are allocated subframes appearing prior to the given (P)MCH. I.e. in the latter case, the order of the (P)MCH in the list defines which which subframes are allocated to a given (P)MCH i.e. the (P)MCH listed first takes the first subframe up to reaching its size, and so on.

Possible Signalling Scheme

The following ASN.1 shows a possible way to signal the parameters indicated in the previous.

```
-  Extract from 6.2.2: Message definitions
MBSFNAreaConfiguration ::= SEQUENCE {
  commonSubframePool  SEQUENCE  {SIZE
(1..maxMBSFN-Allocation))  OF BOOLEAN,
  -- True indicates that the corresponding subframeConfig as included
  in SIB2
  -- is part of the common pool, applicable for the MBSFN area configured
  -- by this message
  commonAllocationPeriod  ENUMERATED {rf1, rf2, rf4, rf8,
  rf16, rf32}
  pmch-ConfigList  PMCH-ConfigList,
  mbms-SessionList  MBMS-SessionList,
  ...
}
PMCH-ConfigList ::=  SEQUENCE (SIZE (1..maxPMCH-
PerMBSFN)) OF PMCH-Config
-- Details of some parameters are not relevant for this invention and
hence not shown
-  Extract from 6.3.7: MBMS information elements s
  PMCH-Config ::=  SEQUENCE {
  msap-Config  MSAP-Config,
  modulationAndCodingScheme  INTEGER (0..63),
  msap-OccasionPeriodicity  ENUMERATED {
                    ms160, ms320, ms480, ms640, ms800, ms960,
                    ms1280, ms1600}
}
MSAP-Config ::=  SEQUENCE {
  allocationStart  INTEGER (0..191),
  allocationSize  INTEGER (1..192)
}
```

### Example

An example is provided to illustrate the invention

SIB2 SAPs

The field mbsfn-SubframeConfigList is set, as illustrated by the following ASN.1 extract, to include:

a) one SAP in which sub-frame 6 is allocated in every radio frame and

b) one SAP in which sub-frame 1 is allocated in every uneven radio frame:

c) one SAP in which sub-frame 8 is allocated in every radio frame and

```
-  mbsfn-SubframeConfigList example setting
mbsfn-SubframeConfigList ::=  {
  {radioframeAllocationPeriod  n1,
  radioframeAllocationOffset  0,
  subframeAllocation: oneFrame  ‘000100’
  },
  {radioframeAllocationPeriod  n2,
  radioframeAllocationOffset  1,
  subframeAllocation: oneFrame  ‘100000’
  },
  {radioframeAllocationPeriod  n1,
  radioframeAllocationOffset  1,
  subframeAllocation: oneFrame  ‘000001’
  }
}
```

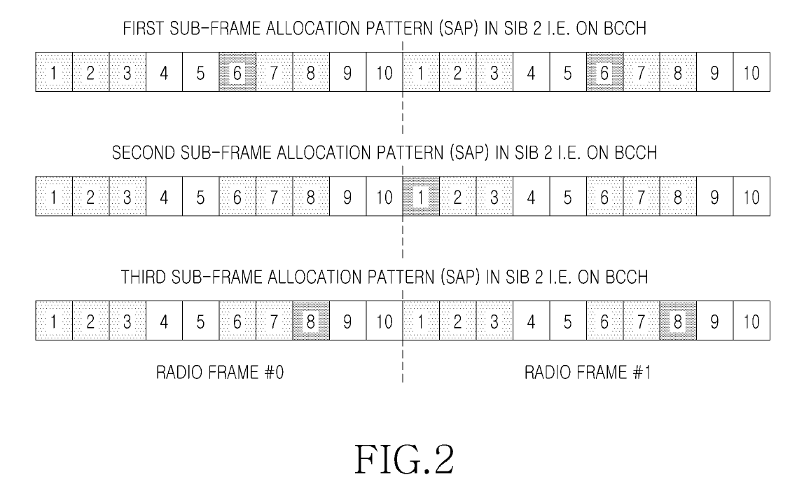

FIG. 2 illustrates the three SIB2 SAPs in a graphical manner. The figure shows two radio frames with the subframes marked light grey are the ones that can be allocated to mbsfn, while the ones marked dark grey are actually allocated for the concerned SAP.

Common Subframe Pool

The field commonSubframePool in certain embodiments is set to include the first and the second SAP included in SIB2 i.e. the third SAP is used for other purposes e.g. relaying.

The field commonAllocationPeriod could be set to rf2, but there are only 3 subframes allocated in such a period so it would not be possible to divide the subframes in this common pool with fine granularity. Hence, a value of rf8 is used for the commonAllocationPeriod. In such a period there are 12 subframes in the common pool. It may be attractive to use even larger values, however this value serves well to illustrate the principles.

The field pmch-ConfigList includes 2 PMCHs. For the PMCH corresponding with the first entry in this list, the allocationStart is set to 0 while the allocationSize is set to 7 (both fields are within the field msap-Config). The parameter values for the second PMCH are 8 and 5 for allocationStart and allocationSize respectively. In other words the first 7 subframes are allocated to the first (P)MCH and the remaining 5 to the 2nd (P)MCH.

In this example we assume that the field msap-OccasionPeriodicity is set to 640 ms i.e. the eNB accumulates user data corresponding with both of these PMCHs for a z period of 640 ms, with user data corresponding to a particular service in subsequent subframes and provides scheduling information i.e. indicating where each service starts accordingly.

The above settings are reflected by the following ASN.1 extract:

```
-  Extract from 6.2.2: Message definitions
mbsfnAreaConfig MBSFNNAreaConfiguration ::=  SEQUENCE {
  commonSubframePool  {{true}, {true}, {false}},
  commonAllocationPeriod  rf8,
  pmch-ConfigList  {
    {msap-Config  {
    allocationStart  0,
    allocationSize  7,
    },
    modulationAndCodingScheme  INTEGER (12),
    msap-OccasionPeriodicity  ms640},
    {msap-Config  {
    allocationStart  8,
    allocationSize  5
    },
    modulationAndCodingScheme  INTEGER (12),
    msap-OccasionPeriodicity  ms640},
  },
  mbms-SessionList  --not shown since this is irrelevant for
  this invention
  ...
}
```

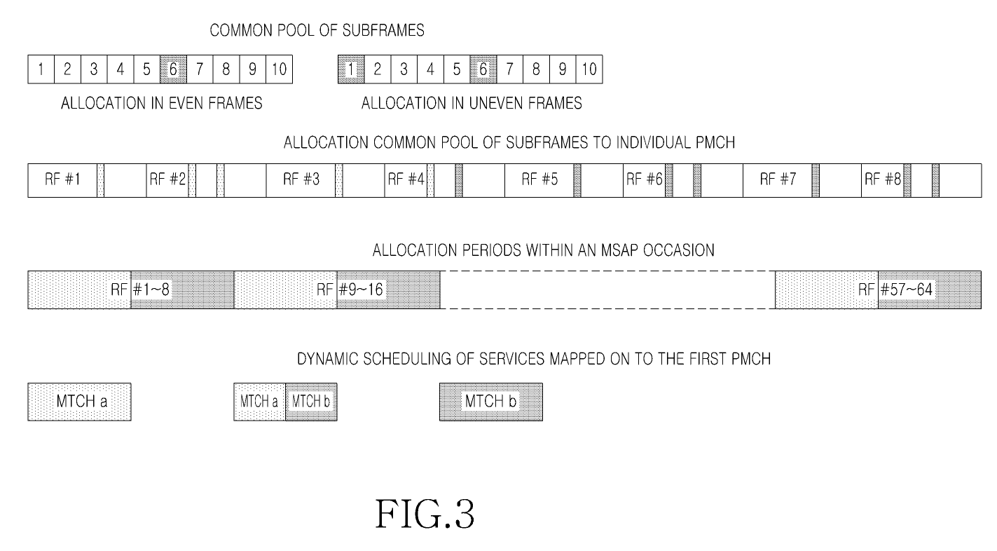

FIG. 3 illustrates the allocation of the common subframes to individual PMCHs in a graphical manner. The figure first illustrates the common pool of subframes using grey marking. Next, the figure shows the division of these subframes within an allocation period between the two PMCHs, using light grey and dark grey marking to distinguish the two PMCHs. Thirdly, the figure illustrates these allocation period as part of an MSAP occasion, illustrating that when the allocation period is smaller than the MSAP occasion the subframes of the two PMCHs are interleaved (using the same shades of grey to distinguish the PMCH). Finally, the figure illustrates the scheduling of two services that are mapped on the first PMCH.

Further details regarding UE operation in embodiments of the invention are as follows.

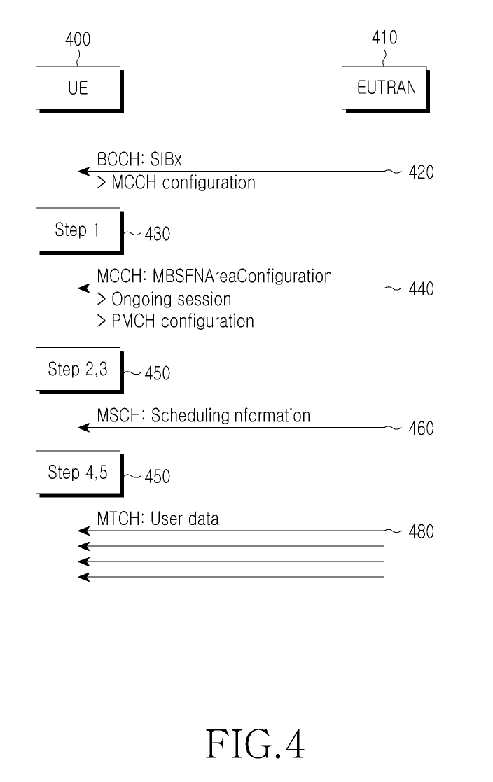

The UE operation associated with the fields described in the invention proposal is first summarised by means of the high level message sequence shown in FIG. 4, which also indicates a number of steps in the UE operation that are described in further detail afterwards.

Further description of the steps in UE operation:

1. A UE supporting MBMS acquires the MBMS control information from BCCH. This mainly concerns information required to acquire the further MBMS control information that is provided on MCCH

2. Such a monitors the MCCH to see if there is a session ongoing of any of the MBMS services he is interested in.
It is currently still under discussion whether the UE needs to periodically monitor MCCH to detect e.g. start of a session of an MBMS service. Alternatively, the UE is being notified of (some of the) MCCH changes, in which case the UE acquires MCCH upon receiving such a notification (as well as in some exceptional cases)
In the description provided in the previous, the list of ongoing services are indicated by the field mbms-SessionList within the MBSFNAreaConfiguration message. The field also indicates on which PMCH the service is provided, as well as which (short) identity is used for the session

3. If the UE decides to receive one of the ongoing sessions, it acquires the further details regarding the radio resource configuration applicable for the service
A UE is assume to typically receives a single MBMS service at a time, but reception of multiple services at the same time is not precluded
The UE determines which subframes are allocated to the PMCH based on the following fields:
   commonSubframePool: indicates the superset of subframes allocated for this MBSFN area
   commonAllocationPeriod: indicates a periodic cycle that is used to sub-divide the common subframes between the PMCHs
   allocationSize (for the concerned PMCH): indicates how many successive subframes out of the common pool and within the allocation period are allocated to the concerned PMCH
   allocationStart (for the concerned PMCH): indicates the first subframe out of the common pool and within the allocation period that is allocated to the concerned PMCH.
   In case the field allocationStart is not provided, the UE determines the allocationStart by adding up the allocationSize values of all PMCHs that are listed prior to the concerned PMCH (i.e. the PMCH which the UE is interested to receive)

4. At the start of each MSAP occasion, the UE may acquire the dynamic scheduling information that indicates which subframes of the subframe s allocated to the PMCH are allocated to the specific service(s) the UE is interested to receive
This is an option for the UE to further reduce power consumption i.e. the UE may enter some kind of sleep during subframes in which no MBMS service is provided (depending on whether unicast reception is ongoing in parallel)

5. For each MSAP occasion, the UE receives the corresponding subframes i.e. as a minimum the subframes that include user data for the MBMS session the UE is interested to receive

In summary, elements of certain embodiments of the invention are as follows:
Creating a common subframe pool based on the subframe allocation patterns included in SIB2
Allocating subsequent subframes out of this common pool to individual (P)MCHs

Advantages provided by certain embodiments are as follows:
It is possible to achieve better granularity when dividing the MBSFN resources between (P)MCHs
It is possible to achieve more concentration of data for a given service, which reduces the time the UE needs to be awake to receive a given service
In some cases it is possible to reduce the overall signalling load (e.g. the case of the example)
The signalling to be included in SIB2 can be reduced i.e. finer granularity can be provided by multiple SAPs rather than by using a pattern of four frames
The additional signalling on MCCH is quite limited
It is assumed that the overall signalling overhead can be reduced, based on the assumption that SIB2 is transmitted more frequently than the MCCH message

Furthermore, the complexity of the proposed scheme is rather limited.

It will be appreciated that in certain embodiments, the number of subframes in the sub-set allocated to a particular channel can range from 1 up to the maximum number of available sub-frames.

It will be appreciated that, in certain embodiments, the terminology usage is as follows:

a) SUPER-SET: a general pool of subframes reserved for future use (mbsfn or other purposes), which is indicated in a SIB on BCCH (SIB2)

b) SET OF SUB-FRAMES for plurality of channels: a specific pool of subframes reserved for one purpose (or more specifically an mbsfn area), but common for all MCH of the MBSFN area,

c) SUB-SET OF SUB-FRAMES for single channel: a subset allocated to an individual channel (MCH)

In certain embodiments, the indication of a set of subframes common for multiple data channels is in fact per MBSFN area (i.e. not generally for MBSFN) i.e. in case we have multiple MBSFN areas, we have more than one of such common sets.

In certain embodiments, the “super-set” is the set reserved for future use (the future use in certain embodiments can include MBSFN use and at least one other use), and the “set” of subframes corresponds to those sub-frames allocated to carrying data of the “plurality of data channels”, e.g. the MCH.

In certain embodiments, the flagging of which of the SAPs generally reserved for future apply for an MBSFN area is done on MCCH.

It will be appreciated that in certain embodiments, the apparatus may be provided with just one parameter to provide an indication of both the length and starting “position” of each sub-set. For example, even when the apparatus is provided with just one parameter, e.g. the length of each sub-set, it is being provided with an indication of length and an indication of where each first sub-frame of each sub-set can be found, because the UE can work out where each subset starts from the length information.

In certain embodiments, the method provides the receiving apparatus (e.g. UE) with indications of

a) a general pool of subframes reserved for future use (mbsfn or not)

b) a specific pool of subframes reserved for an mbsfn area,

c) a subset allocated to an individual channel

With regard to how the common sub-frame pool is indicated in certain embodiments of the invention, there may be a general pool of sub-frames reserved for future use and in certain embodiments we have some signalling to allocate part of this general set to MBSFN while other parts could be used for other purposes. The common pool in certain examples is a pool of sub-frames for one MBSFN area, of which there could be multiple (so part of the general set could be allocated to another MBSFN area also). Certain embodiments then divide the common pool between the MCH sharing this common pool (i.e. having the same MBSFN area).

In certain embodiments, the indication of the length (number of sub-frames) and “position” of each sub-set can be signalled in a variety of ways. For example, one can:
1) signal two parameters, e.g. the start and size, the start and end of each sub-set;
2) signal a single parameter, e.g. start, size or duration (other parameters can then be derived), e.g. the end of one channel corresponds with start of the next, the start position of a channel can be determined by adding sizes of preceding channels, etc.

Thus, in embodiments of the invention, the apparatus is provided with an indication, i.e. something that serves to indicate where the first subframe of the or each sub-set can be found. In other words, the apparatus is provided with something/some information from which it can derive the start position of each sub-set.

Further information relevant to embodiments of the present invention is as follows.

An MBSFN area is an area covered by cells that are transmitting content in a synchronous manner (same radio resources, same radio configuration, time synchronised). This only concerns information mapped on the MCH channel (this does not include the SIBs which are on the normal broadcast channel i.e. BCH or DL-SCH).

Some MBMS control information is provided on MCCH. A minimum set of MBMS control information is provided on BCCH, and most of the information is on MCCH (which is specifically for that purpose).

MBMS user data is provided on the MTCH logical channel.

The MCCH and MTCH logical channel information is transmitted via the MCH transport channel, so it is using the MBSFN transfer mode. The MCH transport channel is transmitted via PMCH physical channel.

The MSAP occasion is signalled to the UE at the start point of each period.

Scheduling information is provided at the start point of each MSAP occasion (another term for ‘scheduling period’).

MCCH carries a single message which includes the details of the allocation period as well as the MSAPs and the list of ongoing services as well as their radio other resource configuration specifics.

Also, in certain embodiments of the invention:

Multiple MBSFN areas are supported; a BS may be synchronized with multiple MBSFN areas. A cell may transmit content corresponding with different MBSFN areas (overlapping SFN areas). It is expected that the standard being developed will at least support the signalling. It is undecided if the REL-9 standard will include the full functionality for this.

Multiple MCH support may be provided within an MBSFN area. Use of multiple MCH in an MBSFN area is possible.

PMCH configuration on BCCH (may be on SIB2 or on a separate SIB)

MCS is a part of the PMCH configuration. It is still unclear what will be included on BCCH, but is seems likely that BCCH signals the MCS of the PMCS on which MCCH is mapped i.e. as part of the PMCH configuration

Further background information to the present invention is as follows:
SIB2 includes a number of subframe allocation patterns (SAPs) which together define all subframes allocated to MBSFN (and relaying i.e. other than normal unicast)
the MSAP defines which of the subframes out of the SIB2 SAPs are allocated to a particular MCH
during a dynamic scheduling period, also called an MSAP occasion,

services are transmitted consecutively on the resources allocated to the MCH on which they are mapped. Dynamic scheduling information hence only needs to indicate for each service the start and/or duration

Certain embodiments address and provide a solution to the problem of how to allocate the subframes out of the SIB2 SAP to individual MCH.

In certain embodiments, this allocation is achieved as follows:
indicate which of the SIB2 SAPs are grouped together i.e. forming a common pool of subframes allocation pattern (common for multiple MCH).
The SIB2 SAPs that are not part of this common pool may be used for other purposes (For example purposes for which it is desirable to have more distributed subframe allocations e.g. relaying).
signal an allocation period, set long enough to achieve the appropriate level of granularity
for each MCH indicate a duration (and possibly an offset, could be calculated from the durations e.g. assuming an ordering of the MCHs).

Then,
The MCH takes, out of the common SAP pool, consecutive subframes
an allocation period can be chosen to achieve sufficient granularity
we can also easily accommodate other purposes for which this consecutive subframe allocations are not desirable”

Thus, in certain embodiments, one does not say that each allocation in SIB2 corresponds with a given service, but one takes all of them together (excluding some that may be used for relays) and then allocates the consecutive sub-frames to a service. This mainly gives more flexibility, finer granularity and more concentrated transmission. So, a significant feature of certain embodiments is not taking a sub-set as such, but rather this grouping and allocating to services in a consecutive order.

On a particular MCH service a service applies consecutive subframes out of the set that are allocated for this MCH. The allocation of the total set of MBMS subframes (indicated in SIB2) to specific MCHs can be done in different manners: options embodying the invention will result in more consecutive subframes being allocated to a particular MCH i.e. less interleaving between MCHs. With that option there will also be more concentrated transmission of services, even when not just considering the subframes allocated a particular MCH. This is a result of taking multiple SIB2 allocations together and allocating consecutive subframes to a particular MCH.

MCH is the transport channel. It is still under discussion whether, within an MBSFN area, there is a need to have more than one MCH e.g. to have different MCS for different logical channels.

SIB2 SAPs referred to above are included in SIB-2 (within this MBSFN-SubframeConfigList). The PMCH configuration is partially on BCCH (and it is under discussion whether this will be in SIB2 or in an MBMS specific SIB). It may be the case that, in the future, only the MCS is on BCCH. The rest of the PMCH configuration may be on MCCH.

In certain embodiments of the invention, the MSAP may be indicated by means of a duration (and possibly an offset, could be calculated from the durations e.g. assuming an ordering of the MCHs). An allocation period may also be specified/indicated, but that may be common for all MCH at least on the MBSFN.

Allocation period and duration of MCH may be signalled on MCCH. MSAP may be part of a PMCH configuration. The allocation period may be common to different MCH and may have to be specified at a higher level.

It will be appreciated that in certain embodiments the SAPs in SIB2 can have different allocation periods. This additional allocation period, that is common for the different MCH, should be chosen such that we can have sufficient granularity when dividing the resources in the common pool between the different MCH.

It is anticipated that, in the eventual standard to which certain embodiments of the invention relate, the following will be specified:

All parts of the MSAP signalling:

A) the specification of the common group by reference to the SAPs in SIB2, will also be at a somewhat higher level on MCCH (as for the allocation period)

B) the MSAP allocation signalling i.e. the duration and possibly the offset C) the allocation period.

It will be appreciated that, in certain embodiments of the invention, multiple MBSFN subframe allocation configurations are provided in SIB 2, system information indicates which MBSFN subframe allocations are for all MCHs (common subframe pool), and MCCH in the common subframes provide scheduling information of services of all MCHs.

The Common pool of MBMS subframes may be indicated by:
Common pool=[MBSFN allocation index, MBSFN allocation index, . . . ] or
MBSFN allocation configuration+indicator

The MCCH of the common pool provides the scheduling information of all MCHs
MCH id, Service id, Duration
MCH id, Service id, Duration
Etc.

It will be appreciated that SIB2 includes a list of allocations, each covering either
Up to 6 sub-frames per 1, 2, 4, 8, 16 or 32 radio frames, occurring in the radio frame indicated by offset
Up to 24 sub-frames per 4, 8, 16 or 32 radio frames, occurring in the radio frames starting from offset
A bit set is used to indicate which of the possible sub-frames (1-3, 6-8) within a radio frame are actually allocated
Especially for larger allocations, the granularity is somewhat limited
For each MSAP occasion, scheduling information is provided
Data corresponding to one service is scheduled consecutively
It is assume an MSAP occasion is in the order of 0.5 sec typically e.g. lets assume a value range from 320 ms up to 1.6 s
For MBSFN concentrated allocations seem preferable
When a PMCH uses consecutive sub-frames, data concerning one service is more concentrated, so UE power consumption can be reduced
Since we have no blind HARQ, there is no need to have time diversity
For relays regularly distributed allocation seem preferable
Taking into account HARQ RTT
E.g. one sub-frame every radio frame

One option for signalling is as follows:

MSAP corresponds with one MBSFN-SubframeConfig (as in SIB2)
Just signal the index of the corresponding allocation included in SIB2.

Characteristics of this approach are that it is simple, but granularity is limited, especially for larger allocations, and it seems impossible to allocate consecutive resources for periods exceeding 4 radio frames.

In another option, embodying the invention, MSAP covers:
A number of consecutive sub-frames (identified by size and possibly an offset)
From a sub-set of MBSFN allocations indicated in SIB2
   i.e. some of the allocations may be for other purposes e.g. relay
Signalling parameters:
   sib2-SubFrameAllocations: for each allocation in sib2 a bit indicating if the allocation is for mbsfn
   Allocation period:
   Size: number of ‘consecutive sub-frames allocated to this PMCH
   Offset: may not be really needed

With regard to whether an offset is needed, having no offset may be somewhat less flexible in case of future extensions. It may also be desirable to cover periods up to an MSAP occasion—if one can cover up to 320 ms while the MSAP occasion is 1.28 sec, the services will still be distributed

A further example of the invention is as follows.

SIB2 Signalling
Allocate 1.5 subframe for MBSFN in each radio frame i.e. sub-frame 6 in every radio frame and in addition sub-frame 3 in every uneven radio frame (dark green):
Signalled as follows: one allocation with period set to n1, (offset N/A) and subFrameAllocation set to ‘000100’B (oneFrame) and one allocation with period set to n2, offset set to 1 and subframeAllocation set to ‘001000’B (oneFrame)
Note: the same can be realised, by a single allocation with period set to n4, offset 0 and subframeAllocation to ‘000100 001100 000100 001100’B (fourFrames)
Allocate sub-frame 1 in every radio frame for relaying

MSAP Signalling
Indicate that the first two allocations indicated in SIB2 concern MBSFN
Allocate the first 5 applicable sub-frames of each 8 radio frames to the PMCH indicated on BCCH
Signalled as follows: allocation period set to n8, offset set to 0, size set to 5
The other 7 available sub-frames are allocated to another PMCH

Characteristics of this option embodying the invention are that it provides:
Better granularity
More concentration of data for a given service
Reduction of signalling overhead SIB2
Somewhat additional signalling overhead on MCCH
if we only have size with an allocation period of up to 320 ms
Quite limited complexity scheme

It will be appreciated that using MBSFN mode of operation is a property of the PMCH physical channel i.e. for all upper layer channels that are mapped on to this physical channel MBSFN mode of operation applies. PMCH carries the MCCH (control) and MTCH (traffic) logical channels.

Other physical channels do not employ MBSFN operation, but may carry some MBMS control information. So far the broadcast logical channel (BCCH) is the only channel on which we are considering to have MBMS control information that is not using MBSFN operation. The information on BCCH is mainly the minimum set needed to ‘find’ and read the further control info that is on the MCCH.

Further features and advantages of embodiments of the invention will be apparent from the content of the following appendix:

Appendix 1.

3GPP TSG-RAN2#66b meeting Tdoc [symbol] R2-09xxxx

Los Angelos, U.S.A, 29 Jun.-3 Jul. 2009

Agenda Item: 6.3.2

Souce: Samsung

Title: Further eMBMS control plane details

Document for: Discussion and decision

Introduction

This document discusses some further eMBMS control plane details, in particular those related to subframe allocations.

Discussion

MCH Subframe Allocation Pattern (MSAP)

Subframe Pool Reserved for Future Use (SP-RF)

SIB2 indicates which sub-frames could posssibly used for MBSFN i.e. we can refer to this as the subframe pool reserved for future use (SP-RF). The SP-RF, specified by the field mbsfn-SubframeConfigList in SIB2, is defined by means of a list of Subframe Allocation Patterns (SAPs). See the following ASN.1 extract:

```
    MBSFN-SubframeConfigList ::=  SEQUENCE  (SIZE
    (1..maxMBSFN-
Allocations)) OF MBSFN-SubframeConfig
    MBSFN-SubframeConfig ::= SEQUENCE {
```

| | |
|---|---|
| radioframeAllocationPeriod | ENUMERATED {n1, n2, |
| n4, n8, n16, n32}, | |
| radioframeAllocationOffset | INTEGER (0..7), |
| subframeAllocation | CHOICE { |
| oneFrame | BIT STRING |
| (SIZE(6)), | |
| fourFrames | BIT STRING |
| (SIZE(24)) | |
| } | |
| } | |

Subframe Pool Allocated to MBSFN (SP-AM)

A subset of the SP-RF may be allocated to MBSFN. This subset is referred to as the Subframe pool allocated to MBSFN (SP-AM). It is assumed that only the UEs supporting MBSFN need to be aware of this subset i.e. the SP-AM may be indicated on MCCH. In case the case of multiple MBSFN areas, each MBSFN area has its own MCCH as well as its own (disjunct) subset or subframes allocated. In other words, MCCH includes the subset of subframes allocated to MBSFN and applicable for the MBSFN area applicable for this MCCH.

Hence, the proposal of the present invention is as follows:

Proposal 1: MCCH indicates which subset of the subframe pool reserved for future use, as indicated in SIB2, are allocated to MBSFN and applicable for the MBSFN area applicable for this MCCH.

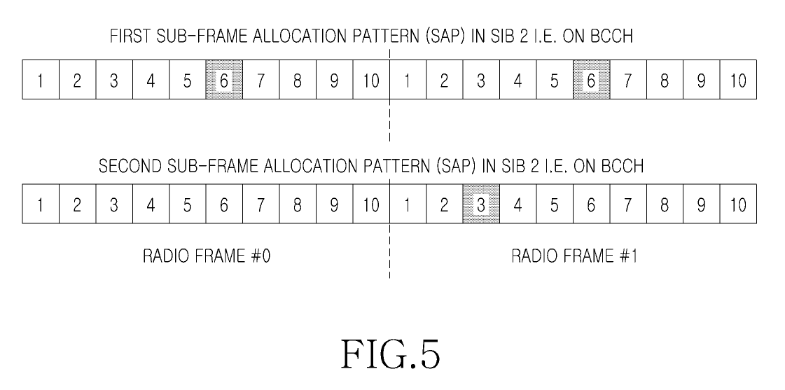

In the previous discussions questions were raised regarding the granulatiry of the current subframe allocation patterns included in SIB2. The issue was acknowledged, but it was felt that this could be addressed as part of the MCCH signalling. Although we are reluctant to introduce additional complexity, we can agree that a somewhat finer granularity seems desirable. A simple solution would be to specify that more than one SAP as include in SIB2 may be allocated to an MBSFN area. The principle is illustrated by a simple example, see FIG. 5, in which two SAPs be used to allocate 1.5 sub-frames per radio frame. FIG. 5 is illustrated an example of finer granularity by using multiple SAPs. Note that in FIG. 5 light gray indicates subframes that can be allocated to MBSFN while dark gray indicates the subframes that are actually allocated to MBSFN.

So, we furthermore propose:

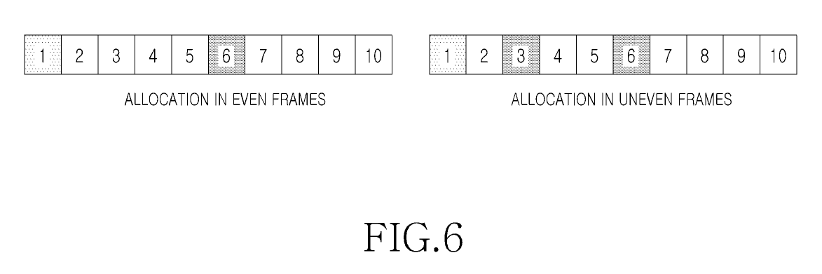

Proposal 2: More than one of the SAPs included in SIB2 may be allocated to a particular MBSFN area i.e. this may be indicated by means of a list of booleans. FIG. 6 is illustrated an example of allocation of 1.5 subframes per radio frame to a given MBSFN area & 1 subframe per radio frame to relaying. The two proposal included in the previous are further illustrated by means of an example in which on average 1.5 subframe per radio frame is allocated for MBSFN (as in FIG. 5), while 1 subframe in each radio frame is allocated for other purposes e.g. relaying (marked grey in FIG. 6).

How to Signal the MCH Subframe Allocation Pattern (MSAP)

The analysis in this document is based on the assumption that multiple MCH are supported, in which case EUTRAN needs to indicate which of the subframes allocated to an MBFSN area apply for a given MCH i.e. it needs to signal an MSAP for each (P)MCH.

Considering that:

From a UE power consumption perspective, it is desirable to allocate subframes to an MCH that are ‘as consecutive as possible’ (i.e. typically a UE is interested to receive only a single service an hence in a single MCH).

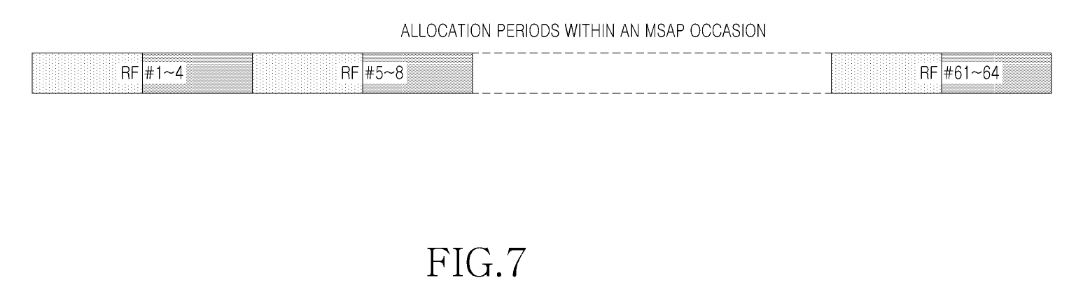

Correspondingly, it would be desirable to avoid excessive inter-leaving between MCHs within an MSAP occasion (e.g. as shown in FIG. 7). This means, it would be desirable for the duration of the MSAP to have a similar value range as the MSAP occasion. FIG. 7 is illustrated an example of interleaving of MCH in case of MSAP duration of rf4 (4 radio frames) and MSAP occasion of rf64.

In case HARQ repetitions would be used, support of distributed allocations could be beneficial (because of the additional time-diversity. However, the current working assumption is to avoid the associated complexity considering the limited gains.

For the MSAPs a somewhat finer level of granularity compared to the SAPs currently defined in SIB2 is considered to be required. Use of a larger pattern duration automatically increases the granularity.

For a concentrated allocations, the signalling can be simple. In particular, in case subsequent subframes are allocated to one MCH it is sufficient to signal a single parameter for each MCH i.e. a start, a size or an end.

Our proposal is as follows:

Proposal 3: An allocation period is configured that is common for all (P)MCH of an MBSFN area, which can have a value range that is in the same order as the value range of the duration of the MSAP occasion.

It should be noted that the MSAP occasion is specific to an MCH. Furthermore, the subframe allocation pool allocated to this MBSFN area may include SIB2 SAPs with different allocation period. The common allocation period should be set to the taking all of this into account.

Proposal 4: Each (P)MCH uses a configurable number of subsequent subframes, out of the set allocated to the concerned MBSFN area. Consequently, only a single parameter needs to be signalled for each (P)MCH i.e. a start, a size or an end.

The proposals included in the previous are further illustrated by means of an example with the following characteristics:

On average 1.5 subframe per radio frame is allocated for MBSFN (as in FIG. 5), while 1 subframe in each radio frame is allocated for other purposes e.g. relaying (as in FIG. 6).

There is a single MBSFN area, while 2 (P)MCH are used.

The MSAP occasion duration of the first (P)MCH is set to 320 ms, while the second (P)MCH applies an MSAP occasion duration of 640 ms. The common allocation period, i.e. used for the MSAPs of both (P)MCH defined for this MBSFN area is set to 320 ms.

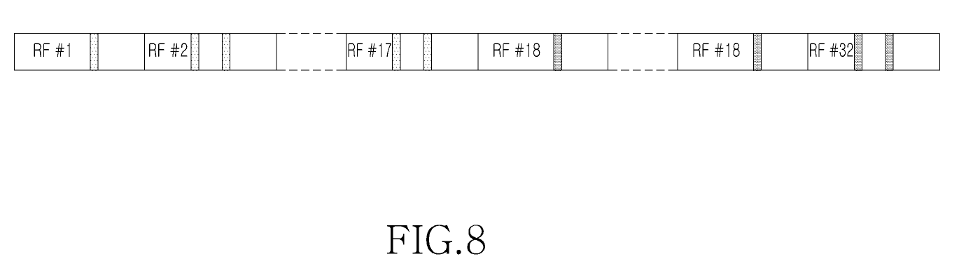

Within the common allocation period, 48 subframes allocated to MBSFN. Of these, the first 27 are allocated to the first (P)MCH (Light Gray), while the remaining 21 are allocated to the second (P)MCH (Dark Gray). FIG. 8 is illustrated an example without MCH interleaving of MCH.

The proposals in the previous result in the following signalling parameters:

Common for the MBSFN area:

Variable size list of booleans indicating which SIB2 SAPs are allocated for this MBSFN area (3-11b)

Common allocation period (4b)

Could possibly be expressed as a multiple of the lowest allocation period of the SAPs in SIB2

Per MCH:

One parameter e.g. start subframe (12b in case allocation period is upto 640 ms or less, depending on granularity).

Subframe allocations for scheduling information and for MCCH.

As a starting point, the example illustrated FIG. 4 is extended to cover the subframe allocations for scheduling information and for MCCH, as follows:

MCCH is mapped to the first (P)MCH.

A modification period of 8 s (i.e. every 8196 radio frames) is used for MCCH, during which 4 identical transmissions are provided i.e. a repetition period of 2 s (every 2048 radio frames) is used.

Scheduling information for the first (P)MCH is provided every 32 frames, while it is provided every 64 frames for the second (P)MCH.

The modification period is a multiple of the common allocation period, which means that whenever MCCH is provided scheduling information is also provided for all of the (P)MCH.

The issue regarding the relative order of MCCH and scheduling information only applies for the first (P)MCH i.e. the one on which MCCH is mapped.

Subframe Allocation for MCCH

It has been agreed to indicate the SAP for MCCH on BCCH. The MCCH SAP is assumed to cover one or more subframes that are part of the MSAP of the (P)MCH on which the MCCH is mapped. However, the MSAP of this (P)MCH may be really sparse e.g. just one subframe in the last radio frame of a fourFrame allocation occuring once every 32 frames. In case for an MSAP like that the MCCH would cover more than one subframe, the MCCH SAP signalling would be rather complicated. In fact, unless we restict the signalling options for the MSAP of the (P)MCH on which MCCH is mapped, we probably end up with with something comparable to what is included in SIB2.

So, it seems worthwhile to seriously discuss which route to go i.e. either:

restrict the allocation options of the MSAP of the (P)MCH on which MCCH is mapped i.e. exclude the more sparse allocations or given the discussion in the previous section, reconsider the alternative of including on BCCH the MSAP of the (P)MCH on which MCCH is mapped.

Proposal 5 RAN2 is requested to discuss which option to adopt to achieve a simple solution for the MCCH SAP i.e. either:

a) restrict the allocation options of the MSAP of the (P)MCH on which MCCH is mapped i.e. to exclude the more sparse allocations or

b) reconsider the alternative of including on BCCH the MSAP of the (P)MCH on which MCCH is mapped.

Subframe Allocation for Scheduling Information

Scheduling Information

A number of companies have indicated that the scheduling information should preferrably be self contained, meaning that if the information is partitioned (because the available space in the transport block is insufficient), the UE should be able to use partial scheduling information. In our understanding this requirement does not only rule out the use of RRC for scheduling information (since the RLC segments can not be used by themselves), but also has implications for the parameters that need to be signalled.

Generally, it seems desirable to limit the scheduling information to a single field i.e: either start, size or end. This seems well possible i.e. when all information is received, a single paramter seems is sufficient to derive the start and end for each service. If however the first part of the scheduling information is not received correctly, only the use of start is useful. In case the last part of the information is not received correctly, the UE may have to continue reading until the end of the scheduling period. If however, the services are scheduled in the order they are indicated on MCCH, the UE knows that it can stop when it detects the LCID of a service that is scheduled later. This suggests that use of parameter start is most promising.

Proposal 6 The scheduling information should only include the start of each service (besides a way to indicate the identity of the service).

Note Please note that it is assumed that all these 3 potential parameters have a comparable size. In particular, the assumption is that it should be possible to allocate all available resources to a single service (so it does not seem possible to use a much smaller size parameter)

Other

Conclusion & recommendation

This paper includes the following proposals, that RAN2 is requested to conclude:

Proposal 1 MCCH indicates which subset of the subframe pool reserved for future use, as indicated in SIB2, are allocated to MBSFN and applicable for the MBSFN area applicable for this MCCH

Proposal 2 More than one of the SAPs included in SIB2 may be allocated to a particular MBSFN area i.e. this may be indicated by means of a list of booleans.

Proposal 3 An allocation period is configured that is common for all (P)MCH of an MBSFN area, which can have a value range that is in the same order as the value range of the duration of the MSAP occasion.

Proposal 4 Each (P)MCH uses a configurable number of subsequent subframes, out of the set allocated to the concerned MBSFN area. Consequently, only a single parameter needs to be signalled for each (P)MCH i.e. a start, a size or an end.

Proposal 5 RAN2 is requested to discuss which option to adopt to achieve a simple solution for the MCCH SAP i.e. either:

a) restrict the allocation options of the MSAP of the (P)MCH on which MCCH is mapped i.e. to exclude the more sparse allocations OR

b) reconsider the alternative of including on BCCH the MSAP of the (P)MCH on which MCCH is mapped.

Proposal 6 The scheduling information should only include the start of each service (besides a way to indicate the identity of the service).

What is claimed is:

1. A method of signalling a sub-frame allocation pattern to unit adapted to receive wirelessly and extract data from a radio signal comprising a series of radio frames, each radio frame comprising a plurality of sub-frames for carrying data, the sub-frame allocation pattern indicating the position of at least each sub-frame, in the series of radio frames, allocated to carry data of one respective data channel of a plurality of data channels, the method comprising:
providing the unit with an indication of a set of sub-frames, in the series of radio frames, reserved for carrying data of the plurality of data channels; and
providing the unit with an indication of at least one sub-set of the set of sub-frames allocated to carry data of a respective one of the data channels.

2. The method in accordance with claim 1, wherein each sub-set comprises at least one of a respective single sub-frame and a respective plurality of consecutive sub-frames from the set.

3. The method in accordance with claim 2, wherein providing the unit with the indication of at least one sub-set comprises providing the unit with an indication of the respective number of sub-frames in each sub-set and the respective position of the first sub-frame of each sub-set in the series of radio frames.

4. The method in accordance with claim 3, wherein providing the unit with an indication of the respective number of sub-frames in each sub-set and the respective position of the first sub-frame of each sub-set in the series of radio frames comprises:
providing the unit with at least one of: a length of each sub-set; a position of the start of each sub-set; and a position of the end of each sub-set, in the set of sub-frames.

5. The method in accordance with claim 1, further comprising:
providing the unit with an indication of a super-set of sub-frames, in the series of radio frames, reserved for at least one use, wherein the set of sub-frames is a sub-set of the super-set.

6. The method in accordance with claim 5, wherein the at least one use includes MBSFN use and at least one different use.

7. The method in accordance with claim 5, wherein the at least one use includes MBMS use and at least one different use.

8. The method in accordance with claims 5, wherein providing the unit with an indication of the super-set of sub-frames comprises:
providing information identifying the sub-frames of the super-set in a System Information Block (SIB).

9. The method in accordance with claim 1, wherein the set of sub-frames is a set reserved for an MBSFN area.

10. The method in accordance with claim 1, wherein providing the unit with an indication of the set of sub-frames comprises:
providing information identifying the set of sub-frames within an MBMS control information message on MCCH.

11. The method in accordance with claim 1, wherein the unit is user equipment (UE).

12. The method in accordance with claim 1, wherein the plurality of data channels are multicast channels.

13. The method in accordance with claim 1, wherein the plurality of data channels are transmitted via a single frequency network.

14. The method in accordance with claim 1, wherein the sub-frame allocation pattern is signalled within an MBMS control information message.

15. The method in accordance with claim 1, wherein the method is implemented in a mobile communication system, the mobile communication system comprising a plurality of access points for forming an MBMS single frequency network area, wherein the multicast channels are synchronized within the MBMS single frequency network area.

16. The method in accordance with claim 8, wherein the system information block is transmitted via a broadcast channel.

17. A method of allocating data to a radio signal in a sub-frame allocation pattern, the radio signal comprising a series of radio frames, each radio frame comprising a plurality of sub-frames for carrying data, the sub-frame allocation pattern indicating the position of at least each sub-frame, in the series of radio frames, allocated to carry data of one respective data channel of a plurality of data channels, the method comprising:
reserving a set of sub-frames, in the series of radio frames, for carrying data of the plurality of data channels; and
allocating at least one sub-set of the set of sub-frames to carry data of a respective one of the data channels.

18. The method in accordance with claim 17, wherein each sub-set comprises at least one of a respective single sub-frame and a respective plurality of consecutive sub-frames from the set.

19. An apparatus of signalling a sub-frame allocation pattern to unit adapted to receive wirelessly and extract data from a radio signal comprising a series of radio frames, each radio frame comprising a plurality of sub-frames for carrying data, the sub-frame allocation pattern indicating the position of at least each sub-frame, in the series of radio frames, allocated to carry data of one respective data channel of a plurality of data channels, the apparatus comprising:
a controller for providing the unit with an indication of a set of sub-frames, in the series of radio frames, reserved for carrying data of the plurality of data channels; and providing the unit with an indication of a at least one sub-set of the set of sub-frames allocated to carry data of a respective one of the data channels.

20. The apparatus in accordance with claim 19, wherein each sub-set comprises at least one of a respective single sub-frame and a respective plurality of consecutive sub-frames from the set.

21. The apparatus in accordance with claim 19, wherein providing the unit with the indication of at least one sub-set comprises providing the unit with an indication of the respective number of sub-frames in each sub-set and the respective position of the first sub-frame of each sub-set in the series of radio frames.

22. The apparatus in accordance with claim 21, wherein providing the unit with an indication of the respective number of sub-frames in each sub-set and the respective position of the first sub-frame of each sub-set in the series of radio frames comprises:
providing the unit with at least one of: a length of each sub-set; a position of the start of each sub-set; and a position of the end of each sub-set, in the set of sub-frames.

23. The apparatus in accordance with claim 19, the controller comprises providing the unit with an indication of a super-set of sub-frames, in the series of radio frames, reserved for at least one use, wherein the set of sub-frames is a sub-set of the super-set.

24. The apparatus in accordance with claim 23, wherein the at least one use includes MBSFN use and at least one different use.

25. The apparatus in accordance with claim 23, wherein the at least one use includes MBMS use and at least one different use.

26. The apparatus in accordance with claims 23, wherein the controller comprises providing information identifying the sub-frames of the super-set in a System Information Block (SIB).

27. The apparatus in accordance with claim 19, wherein the set of sub-frames is a set reserved for an MBSFN area.

28. The apparatus in accordance with claim 19, wherein the controller comprises providing information identifying the set of sub-frames within an MBMS control information message on MCCH.

29. The apparatus in accordance with claim 19, wherein the unit is user equipment (UE).

30. The method in accordance with claim 19, wherein the plurality of data channels are multicast channels.

31. The apparatus in accordance with claim 19, wherein the plurality of data channels are transmitted via a single frequency network.

32. The apparatus in accordance with claim 19, wherein the sub-frame allocation pattern is signalled within an MBMS control information message.

33. The apparatus in accordance with claim 19, wherein an operation of the controller is implemented in a mobile communication system, the mobile communication system comprising a plurality of access points for forming an MBMS single frequency network area, wherein the multicast channels are synchronized within the MBMS single frequency network area.

34. The apparatus in accordance with claim 26, wherein the system information block is transmitted via a broadcast channel.

35. An apparatus of allocating data to a radio signal in a sub-frame allocation pattern, the radio signal comprising a series of radio frames, each radio frame comprising a plurality of sub-frames for carrying data, the sub-frame allocation pattern indicating the position of at least each sub-frame, in the series of radio frames, allocated to carry data of one respective data channel of a plurality of data channels, the apparatus comprising:
a controller for reserving a set of sub-frames, in the series of radio frames, for canying data of the plurality of data channels and allocating at least one sub-set of the set of sub-frames to carry data of a respective one of the data channels.

36. The apparatus in accordance with claim 35, wherein each sub-set comprises at least one of a respective single sub-frame and a respective plurality of consecutive sub-frames from the set.
